(19) United States
(12) Patent Application Publication
(10) Pub. No.: US 2005/0226096 A1
(43) Pub. Date: Oct. 13, 2005

(54) High capacity drum for an agitating retort

(75) Inventor: Eduard Hendrikus Johannes Damhuis, Bousval (BE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: FMC Technologies, Inc.

(21) Appl. No.: 10/820,834

(22) Filed: Apr. 8, 2004

(51) Int. Cl. B01F 9/00

(52) U.S. Cl. 366/234

(57) ABSTRACT

An agitating retort (118) includes a drum (122) designed to fit closely within an outer shell (120) for rotation of the drum within the shell. The drum is perforated to permit water and/or steam to circulate through the drum during the retorting process. A plurality of interior transverse plates (130) are spaced apart along the interior of the drum to provide structural integrity thereto. The central portions of the plates (130) are open for receiving baskets (134) therein which receive containers of the foodstuffs or other products to be processed within the retort.

### FIELD OF THE INVENTION

The present invention relates to retort systems for in-container preservation of foodstuffs, and more particularly to an agitating retort designed for high capacity.

### BACKGROUND OF THE INVENTION

Agitating retorts are widely used for in-container preservation of foodstuffs, either for pasteurization or sterilization processes. FIGS. 1 and 2 illustrate the construction of a known agitating retort 18, consisting of an outer retort shell 20 which in essence is a generally cylindrically shaped pressure vessel that houses a drum 22 that rotates within the shell. The drum is adapted to receive baskets 24 within which containers of foodstuffs are stacked. The containers may be in the form of cans, glass jars or of other types. Alternatively, the foodstuff containers may be arranged on trays carried by pallets, not shown. The baskets of foodstuff containers are clamped in place within the drum to retain the baskets and containers during rotation of the drum.

Hot water, steam, or a combination of both (process fluid) are circulated through the drum to carry out the pasteurization or sterilization process. The process fluid may be introduced into the agitating retort 18 through a number of inlets that may be located above the drum over the length of the retort shell to partially or substantially fully fill the shell with process fluid. The process fluid may also be introduced onto the retort through distribution pipes extending lengthwise within the retort shell, exterior to and above the drum. Holes or spray nozzles may direct the water spray or steam/water spray downwardly from the distribution pipes onto the rotating drum and over and between the foodstuff containers carried by the baskets. The processing fluid from the holes or the nozzles collects at the bottom of the shell for removal.

The drum 22 is shown of open design and is constructed from a number of spaced-apart vertical disks 30 that are joined together with a series of longitudinal tube structures 32 spaced about the perimeter portion of the disks to provide structural strength of the drum 22. Reinforcing braces 34 may be welded between the tubes in a criss-cross pattern for further structural strength and/or rigidity. A door 36 is used to close off the open end of the shell 20 through which the baskets 24 holding the containers are loaded into and unloaded from the drum 22. The drum 22 may be rotatably supported by rollers 38 located in the lower portion of the retort shell 24 and bearing against the outer surface of the drum 22. A powered drive shaft 40 may be coupled to the end of the drum opposite the door 36 for rotation of the drum.

As shown in FIG. 2, generally square or rectangular shaped openings 42 are formed in the disks 30 for receiving the baskets 24. Various types of clamping systems, not shown, may be used to hold the containers and the baskets in place when the drum is rotated. As apparent, the tube structures 32 occupy a significant space within the drum and thus limit the cross-sectional size of the baskets 24 that can be accommodated by the drum. It will be appreciated that the throughput of an agitating retort can be increased if the drum were designed to accommodate baskets that occupy a larger cross-sectional area of the drum than is currently possible. The present invention seeks to address this issue as well as other issues, as described below.

### SUMMARY OF THE INVENTION

In accordance with the teachings of the present invention, an agitating retort is described as composed of an outer shell and a cylindrical drum sized to be closely receivable and rotatable within the shell. The drum is perforated about a substantial portion of its surface to allow passage of processing fluids into and out of the drum during operation of the retort. One or more reinforcing structures are used to reinforce the drum to enhance its structural integrity. Such reinforcing structure strengthens the drum in bending, torsion and/or in hoop strength.

The reinforcing structures for the drum may be composed of a plurality of spaced apart transverse reinforcing walls positioned within the drum so that the outer perimeter of such circular walls fixedly engages the inside diameter of the drum. The central portions of such reinforcing plates are open for receiving baskets or other structures used to hold product containers.

In alternative to, or in addition to, the reinforcing plates, the structural integrity of the drum can be enhanced by using interior and/or exterior rings at the ends of the drum or at locations intermediate the ends of the drum. Further, structural members may be positioned lengthwise of the drum on the interior and/or exterior of the drum. Such structural members may include rods, tubes, angles, channels, or other structural shapes.

### BRIEF DESCRIPTION OF THE DRAWINGS

The foregoing aspects and many other attendant advantages of this invention will become more readily appreciated by reference to the following detailed description, when taken in conjunction with the accompanying drawings, wherein:

FIG. 1 is a schematic side elevational view of a prior art agitating retort structure;

FIG. 2 is a schematic cross-sectional view of FIG. 1, taken substantially along lines 2-2 thereof;

FIG. 3 is a partially schematic longitudinal view partially in cross-section of an agitating retort constructed in accordance with one embodiment of the present invention;

FIG. 4 is a substantially schematic view of FIG. 3, taken substantially along lines 4-4 of FIG. 3;

FIG. 5 is an isometric view, partially in schematic, of a segment of a drum constructed according to the present invention taken from one end thereof;

FIG. 6 is a view similar to FIG. 5, but taken from the opposite end of the drum segment; FIG. 7 is a partial cross-section view of a further embodiment of the present invention corresponding to FIG. 4.

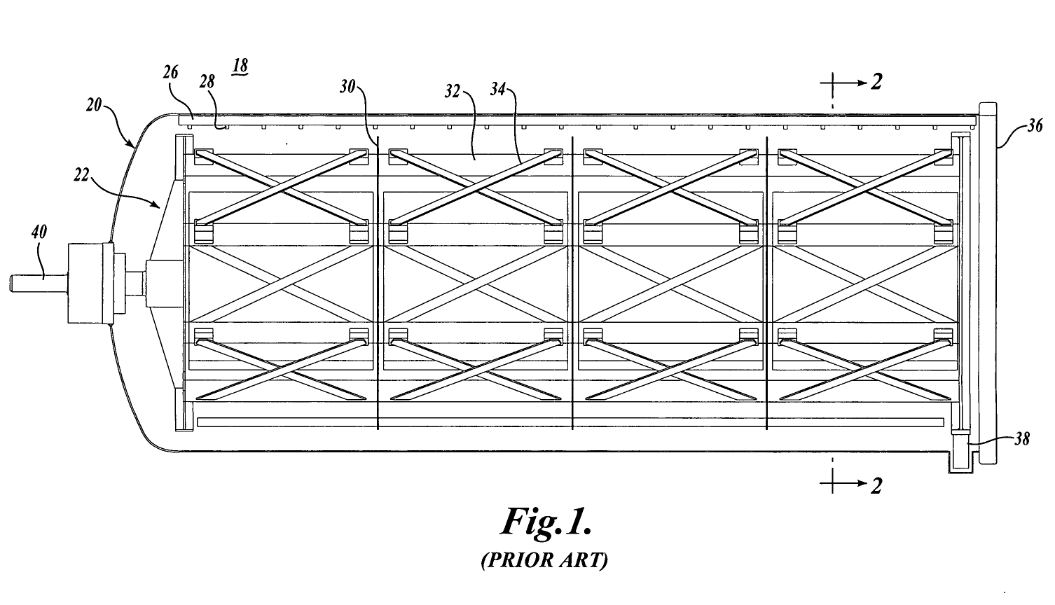

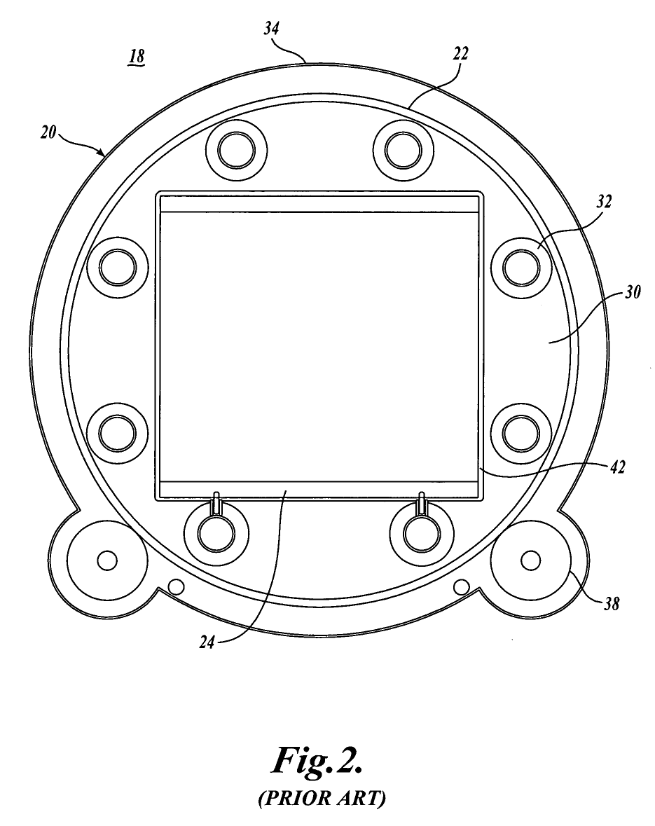

### DETAILED DESCRIPTION OF THE PREFERRED EMBODIMENT

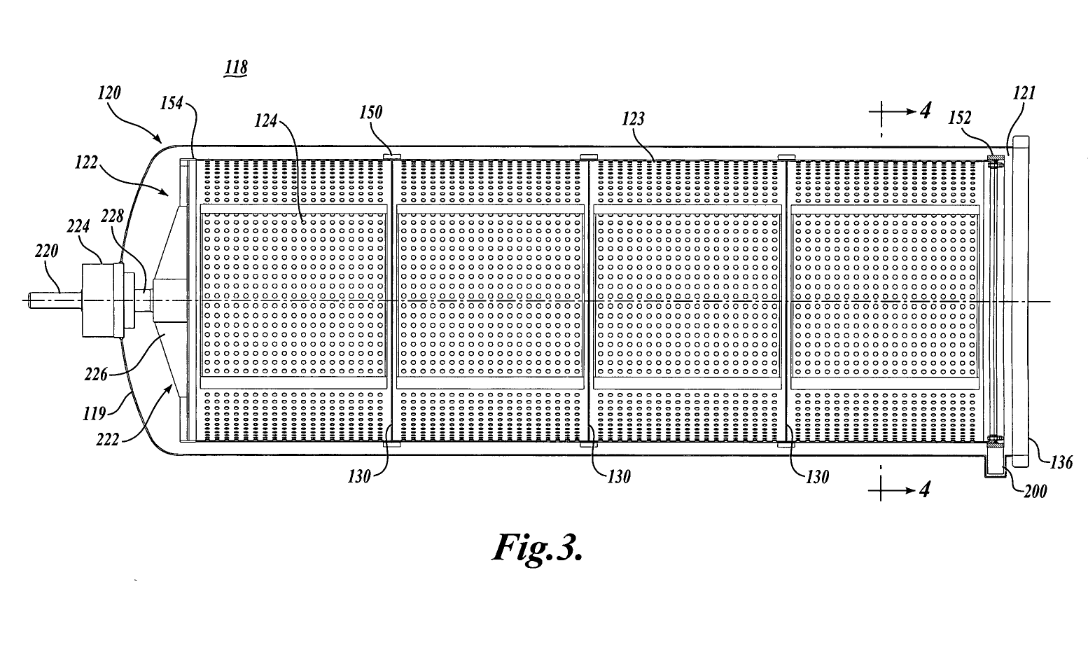

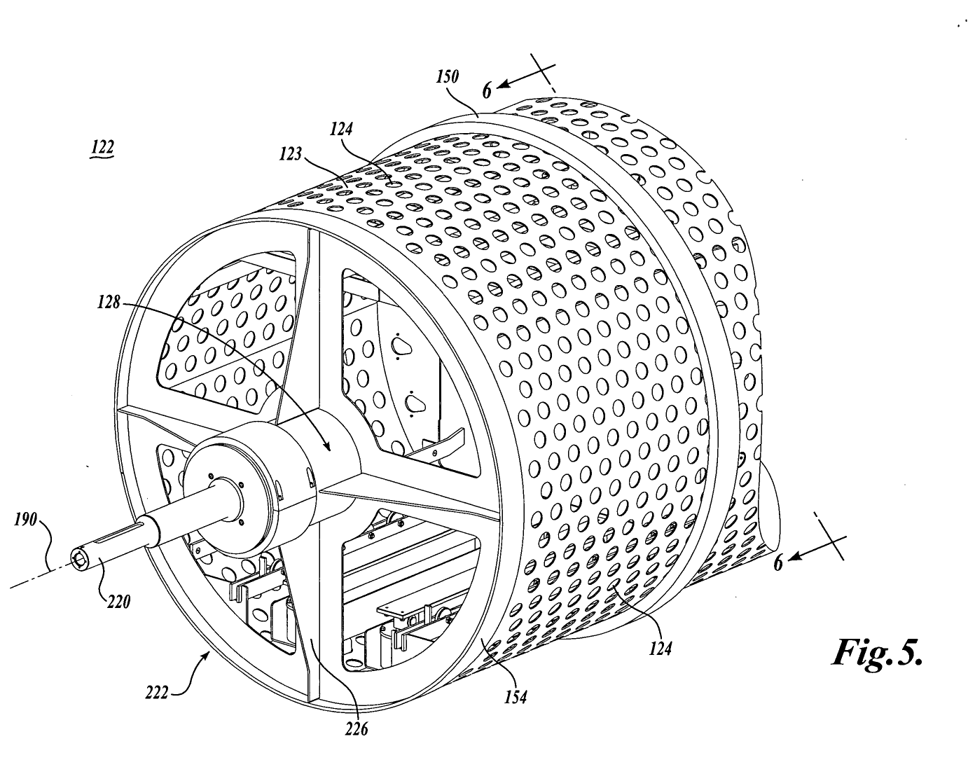

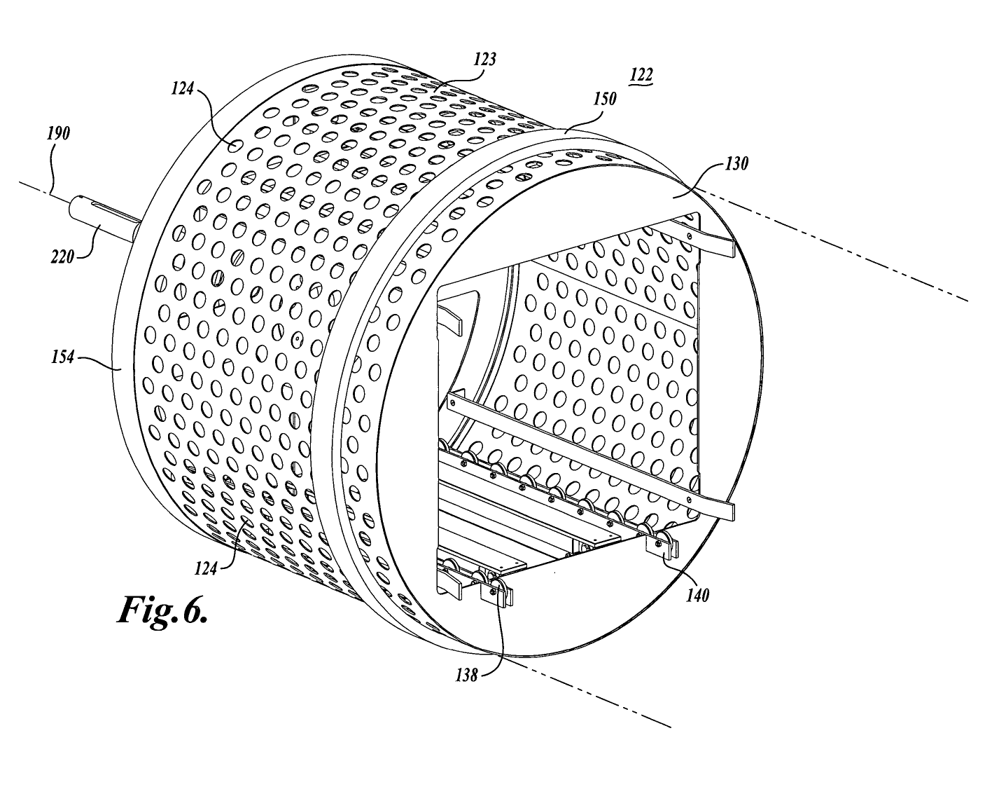

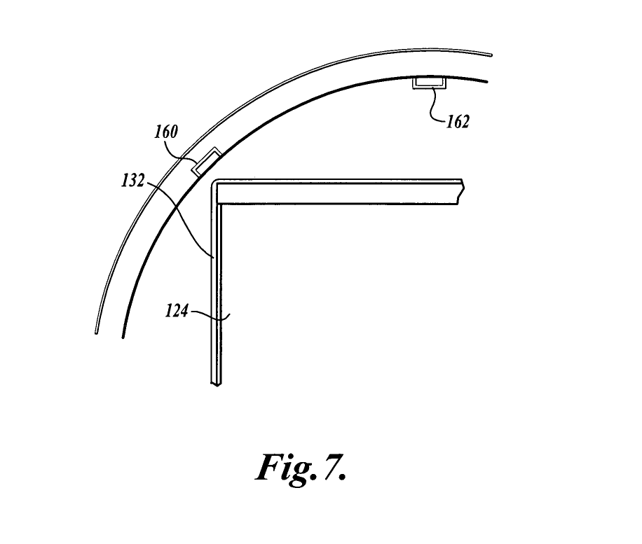

Referring initially to FIGS. 3-6, the agitating retort 118 includes a generally cylindrically shape shell 120, having a closed end portion 119 which is convex in shape in a manner typical of pressure vessels, and an open opposite end portion 121 that is closable by a door 136 in a manner typical of agitating retort constructions. Thus, these features of the present invention will not be described in detail.

The focus of the present invention includes a new and novel drum construction 122, which may be utilized in conjunction with existing retort shells or new retort structures. The drum 122 is designed to be close fitting within the retort. The clearance between the exterior of the drum and the interior of the shell 120 may be in the range of from about 2 to 6 cm.

As shown in FIG. 3, the drum 122 is in the form of a perforated cylinder 123. The drum can be composed of a single structural member, for example, a flat perforated plate that is rolled into a cylindrical shape. Alternatively, the drum 122 could be constructed of sections of perforated plates that are rolled to form segments of the drum, with the segments then welded or otherwise attached together in both the axial and circumferential directions.

The perforations 124 in the drum cylinder 123 are provided for the purpose of enabling water, steam or other process fluids to enter and exit the drum. The perforations 124 are illustrated as being circular in shape, but can be of numerous other shapes, such as square, triangular, oval, diamond or slot shaped. Also, though the round perforations 124 are shown as arranged in circumferential rows and straight lines along the length of the drum, the perforations can be arranged in numerous other patterns, such as offset from each other from row to row, or in a spiral pattern about the drum cylinder 123. The drum cylinder may also be only partially perforated in a pattern that provides higher strength and/or stiffness in function of the mechanical loads during operation. Also, the size and number of perforations may vary with different factors, for example, the thickness of the drum wall, the speed of rotation of the drum, the type of working medium, whether water, steam, or a combination, as well as other factors. As one specific but non-limiting embodiment, the circular perforations may be approximately 50 mm in diameter and arranged on 90 mm centers, providing an open area of about 28%. Other percentages of open area provided by the perforations may be utilized. One design criteria of the present invention in this regard is to provide sufficient open area in the drum to allow for adequate circulation of the working medium into and out of the drum, while at the same time maintaining the strength and structural integrity of the drum.

The drum may be composed of numerous different types of materials, including carbon steel, stainless steel, and other appropriate materials. The diameter and length of the drum, as well as the material composition of the drum, will be a factor in the wall thickness of the drum cylinder. Another factor in the wall thickness of the drum cylinder is the type(s) of bracing and amount of bracing utilized with the drum, as described below.

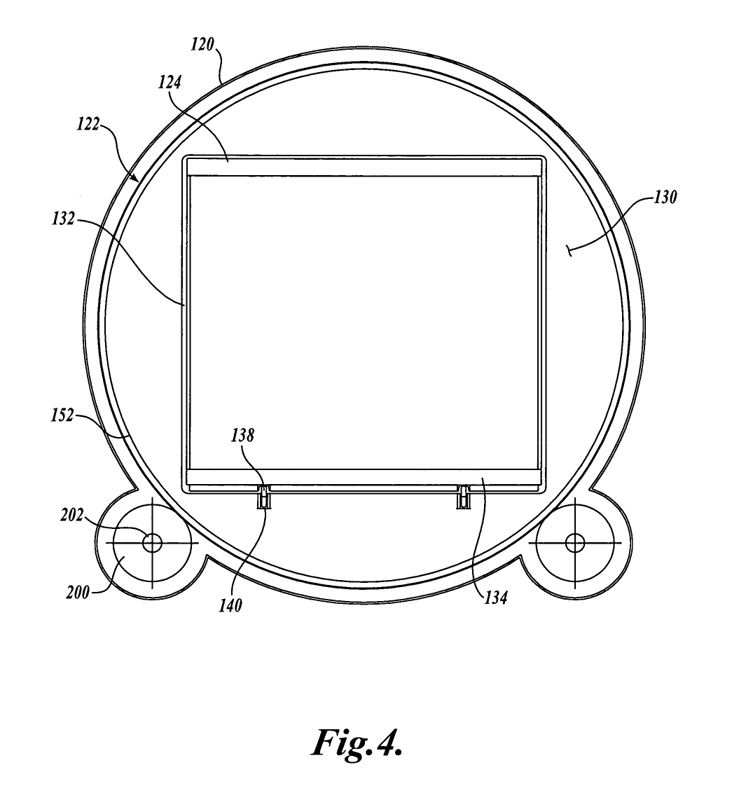

One type of bracing or reinforcement utilized with drum 122 consists of generally circularly shaped plates or disks 130 disposed transversely in the interior of the drum and spaced apart along the length of the drum. The plates 130 are sized to be closely receivable within the interior of the drum, with the perimeter of the plates fixedly attached to the interior surface of the drum by welding, bolting, or otherwise. It will be appreciated that such plates can vastly increase the torsion strength and hoop strength of the drum. Openings 132 of generally square or rectangular shape are formed in the central portion of the plates 130 for reception of baskets 134. Rollers 138 may be axle to the bottom portions of the baskets 134 to ride within grooved rails 140 extending longitudinally of the drum 122. Alternatively, a series of rollers 138 can be axle within the drum in aligned relationship to support the bottom portions of the baskets 134. As shown in FIG. 4, the openings 132 may extend almost to the outer perimeter of the plates 130, thereby maximizing the cross-sectional size of the baskets 134 receivable within the drum. Although the plates 130 are shown in FIG. 4 as being of solid construction (other than opening 132), the plates can be perforated or otherwise include openings to lighten the construction of the drum and also to allow for circulation of water and/or steam through the plates.

In place of or in addition to plates 130, the drum 122 may be reinforced in other ways. For instance, reinforcing rings 150 may extend around the exterior of the drum in registry with the locations of the plates 130 or at other locations along the length of the drum. Corresponding or other rings, not shown, may be positioned in the interior of the drum, bearing against the inside surface of the drum. Also reinforcing rings 152 and 154 may be positioned to extend longitudinally from the opposite ends of the drum. The rings 150, 152 and 154 may be fixedly attached to the drum by welding, bolting, clamping or otherwise.

The drum 122 may be alternatively or additionally reinforced by structural members extending longitudinally of the drum. These structural members could be rods, tubes of round, square or rectangular shape or profiles of various shapes including U, L or T profiles. The structural members are spaced apart from each other about the exterior or interior circumference of the drum cylinder 123 or both, not shown, and may be fixedly attached to the drum by welding, bolting, clamping or otherwise.

As an example, FIG. 7 illustrates a series of exterior channels 160 extending lengthwise along the exterior surface of the drum. The channels 160 can be spaced apart from each other about the exterior circumference of the drum cylinder 123. Interior channels 162 may in addition or alternatively extend along the interior of the drum, being positioned at spaced-apart locations about the inside surface of the drum. The interior channels 162 may be similar or of different size than the exterior channels 160. The exterior and interior channels may be fixedly attached to the drum by welding, bolting, clamping or otherwise. If plates 130 are used in conjunction with drum 122, then the plates may have openings to provide clearance for the interior channels, or the interior channels may extend between adjacent plates 130. It will be appreciated that the size and number and location of the channels or other structural members may be varied to achieve the desired level of reinforcement. The important factor is that the structural members do not occupy a large distance in the radial direction relative to the drum, while significantly enhancing the structural integrity of the drum, including its bending strength, torsion strength, and hoop strength.

Referring again to FIGS. 3 and 4, the drum 122 is supported for rotation about its longitudinal axis 190. This support may be provided by roller sets 200 adapted to rotate about axes 202, disposed parallel to the drum axis 190. As shown in FIG. 4, the shell 120 may be enlarged at the location of the rollers to house the rollers. Alternatively, a portion of the rollers 200 may extend outwardly of the shell. The rollers 200 are shown in FIG. 3 as positioned adjacent the end of the drum at the open end portion 121 of the shell. However, rollers similar to rollers 200 may also be positioned at the opposite end of the drum as well as at one or more locations intermediate the ends of the drums. In addition, the rollers 200 may ride against the exterior of the drum itself or ride against a ring formed around the drum, for example, rings 150, 152, and 154, described above. The rollers 200 may not only support the drum 122, but also may be powered to rotate the drum. Various systems may be provided to apply rotational torque to the rollers 200.

The drum 122 may be driven other than by powering one or more rollers 200. For example, the drum 122 may be driven by a powered drive shaft 220 that may be coupled to an end structure 222 attached to the end of the drum 122 corresponding to the closed end 119 of the shell 120. A radial thrust bearing structure 224 may be mounted to the shell end structure 119 to support and constrain the drive shaft 220 as it is powered to rotate the drum 122. The end structure 222 may be of various constructions, including composed of a plurality of radial arms 226 extending outwardly from a central hub 228. The outer end portions of the arms 226 may be attached to drum ring 154. By this construction, the end portion of the drum 122 is substantially opened so as not to, significantly restrict the circulation of water and/or steam into and out of the drum. If drive shaft 220 is utilized to rotate the drum 122, rollers similar to rollers 200 may or may not be utilized at the adjacent end portion of the drum 122.

Various embodiments of the present invention have been illustrated and described. In each of these embodiments, the outer diameter of the drum is sought to be maximized with respect to the interior diameter of the shell, thereby maximizing the capacity of the drum to receive baskets 134 or other structures used to hold and support food product containers or other types of containers for processing within the agitating retort 118. Simultaneously, the drum is designed to provide for good circulation of the water and/or steam utilized as the working medium in the retort 118. In the present invention, this is accomplished by providing holes or other perforations or openings in the retort drum 122.

While preferred embodiments of the invention have been illustrated and described, it will be appreciated that various changes can be made therein without departing from the spirit and scope of the invention.

1. A drum structure for engagement within the interior of a retort apparatus having an outer shell, said drum structure comprising:
(a) a generally cylindrical drum sized to be closely receivable within the outer shell, said drum having an inside surface and an outside surface and being perforated about a substantial portion of its surface area to allow passage of fluids into and out of the drum during operation of the retort apparatus;
(b) one or more reinforcing structures for the drum secured to the drum to enhance one or more strength components of the drum selected from the group consisting of the bending strength of the drum, the torsion strength of the drum and the hoop strength of the drum.

2. A drum structure according to claim 1, wherein the reinforcing structure comprises a plurality of spaced-apart reinforcing walls disposed transversely to the longitudinal axis of the drum and intersecting the inside surface of the drum, the central portions of the reinforcing walls being open for receiving products to be processed by the retort apparatus.

3. A drum structure according to claim 2, wherein the reinforcing walls are substantially uniformly spaced apart along the length of the drum.

4. A drum structure according to claim 3, wherein the drum is adapted to receive containers containing product to be processed within the retort apparatus, wherein the central open portion of the reinforcing wall is adapted for receiving said containers.

5. A drum structure according to claim 4, wherein the openings formed in the reinforcing walls are substantially centrally located relative to the circumference of the reinforcing walls.

6. A drum structure according to claim 4, wherein the containers are disposed in baskets receivable within the drum in stacked relationship to each other; and wherein the openings of the reinforcing members are sized to allow passage of the baskets into and out of the drum.

7. A drum structure according to claim 2, wherein the reinforcing structure further comprising one or more reinforcing rings fixed to one or both of the inside surface and outside surface of the drum.

8. A drum structure according to claim 7, wherein the reinforcing rings are attached to one or both end portions of the drum.

9. A drum structure according to claim 8, further comprising reinforcing rings spaced along the length of the drum.

10. A drum structure according to claim 7, wherein the reinforcing ring is attached to the drum by an attachment mode selected from the group consisting of welding, bolting and clamping.

11. A drum structure according to claim 2, wherein the reinforcing structure further comprising one or more reinforcing members disposed generally lengthwise of the drum.

12. A drum structure according to claim 1, wherein the reinforcing structure comprising one or more reinforcing members extending lengthwise of the drum.

13. A drum structure according to claim 1, wherein the perforations therein are shaped in the form of one or more shapes selected from the group consisting of circles, squares, triangles, ovals and slots.

14. An agitating retort, comprising:
a retort outer shell;
a drum structure sized and shaped to be receivable within the shell and to be rotatable relative to the shell, said drum structure comprising:
a generally cylindrically shaped drum being perforated about a substantial portion of its surface area to allow processing fluids into and out of the drum during operation of the retort; and
one or more reinforcing substructures fixed to the interior and/or exterior of the drum to enhance the structural strength of the drum.

15. An agitating retort according to claim 14, wherein said reinforcing substructures comprise a plurality of spaced-apart transverse walls disposed within the drum and fixed to the drum, said transverse walls having openings formed therein for receiving into the drum products to be processed by the retort apparatus.

16. An agitating retort according to claim 15, wherein the openings in the transverse walls are adapted to receive containers containing products to be processed within the retort.

17. An agitating retort according to claim 16, wherein the containers are disposed in baskets receivable within the drum, the containers being stacked in relationship to each other within the baskets, and wherein the openings in the transverse walls are sized to allow passage of the baskets into and out of the drum.

18. An agitating retort according to claim 15, wherein said reinforcing substructures further comprising one or more reinforcing rings extending circumferentially relative to the drum.

19. An agitating retort according to claim 15, wherein said reinforcing substructures further comprising one or more reinforcing members extending lengthwise of the drum.

20. An agitating retort according to claim 14, wherein the reinforcing substructures comprising one or more reinforcing rings attached to one or both of the inside surface and outside surfaces of the drum.

21. An agitating retort according to claim 20, wherein the reinforcing rings are spaced apart along the length of the drum.

22. An agitating retort according to claim 14, wherein the reinforcing substructures comprising one or more reinforcing members extending lengthwise of the drum.

23. An agitating retort according to claim 14, wherein the perforations in the drum are in the shape of one or more shapes selected from the group consisting of circles, squares, triangles, ovals, and slots.
